(19) United States
(12) Patent Application Publication
(10) Pub. No.: US 2024/0377062 A1
(43) Pub. Date: Nov. 14, 2024

(54) INLET HEAD ASSEMBLY

(71) Applicant: Edwards Limited, Burgess Hill, Sussex (GB)

(72) Inventors: Gemma Haf Jones, Clevedon, Somerset (GB); Neil Andrew Maddock, Bristol, Somerset (GB); Gareth David Stanton, Clevedon, Somerset (GB); Alageswaren Reddi Balsamy Radiar, Clevedon, Somerset (GB)

(21) Appl. No.: 18/292,162

(22) PCT Filed: Jul. 28, 2022
(86) PCT No.: PCT/GB2022/051981

§ 371 Date: Jan. 25, 2024

(30) Foreign Application Priority Data
Jul. 30, 2021 (GB) 2110995.4

(51) Int. Cl. F23G 7/06; F23D 14/22

(52) U.S. Cl. CPC F23G 7/065; F23D 14/22; F23G 2209/142

(57) ABSTRACT

An inlet head assembly for an abatement apparatus is disclosed. The inlet head assembly is for an abatement apparatus for abating an effluent stream from a semiconductor processing tool, the inlet head assembly comprises: an inlet head; a pilot nozzle extending within the inlet head and configured to supply at least one pilot combustion reagent stream to a downstream abatement chamber of the abatement apparatus; and a plurality inlet nozzles, each extending within the inlet head and configured to supply an associated effluent stream for abatement within the abatement chamber, the plurality of inlet nozzles being positioned around the pilot nozzle. In this way, the effluent streams are packed closer together around the pilot nozzle which improves the heating of the effluent stream, improving the DRE and reducing heat loss, which enables a reduction in the combustion reagents needing to be supplied.

### CROSS-REFERENCE OF RELATED APPLICATION

This application is a Section 371 National Stage Application of International Application No. PCT/GB2022/051981, filed Jul. 28, 2022, and published as WO 2023/007163A1 on Feb. 2, 2023, the content of which is hereby incorporated by reference in its entirety and which claims priority of British Application No. 2110995.4, filed Jul. 30, 2021.

### FIELD

The field of the invention relates to an inlet head assembly for an abatement apparatus.

### BACKGROUND

Abatement apparatus are known and are typically used for treating an effluent gas stream from a manufacturing process tool used in, for example, the semiconductor or flat panel display manufacturing industry. During such manufacturing, residual perfluorinated compounds (PFCs) and other compounds exist in the effluent gas stream pumped from the process tool. PFCs are difficult to remove from the effluent gas and their release into the environment is undesirable because they are known to have relatively high greenhouse activity.

Known abatement apparatus use combustion to remove the PFCs and other compounds from the effluent gas stream. Typically, the effluent gas stream is a nitrogen stream containing PFCs and other compounds. A fuel gas is mixed with the effluent gas stream and that gas stream mixture is conveyed using an inlet assembly into an abatement chamber for abatement therein.

Although techniques exist for processing the effluent gas stream, they each have their own shortcomings. Accordingly, it is desired to provide an improved technique for processing an effluent gas stream.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect, there is provided an inlet head assembly for an abatement apparatus for abating an effluent stream from a semiconductor processing tool, the inlet head assembly comprising: an inlet head; an axially orientated pilot nozzle extending within the inlet head and configured to supply at least one pilot combustion reagent stream to a downstream abatement chamber of the abatement apparatus; and a plurality inlet nozzles, each extending within said inlet head, angled at an angle between 5° and 60°, preferably between 5° and 45°, and more preferably 5° and 20°, with respect to the axial orientation of said pilot nozzle and configured to supply an associated effluent stream for abatement within said abatement chamber, the plurality of inlet nozzles being positioned around the pilot nozzle.

The first aspect recognizes that a problem with existing arrangements is that combustion reagent consumption to achieve a particular destructive rate efficiency (DRE) of some compounds within the effluent streams can be higher than is desired. Accordingly, an inlet head assembly is provided. The inlet head assembly may be for an abatement apparatus. The abatement apparatus may abate an effluent stream from a semiconductor processing tool. The inlet head assembly may comprise an inlet head. The inlet head assembly may comprise a pilot nozzle. The pilot nozzle may extend within or through the inlet head. The pilot nozzle may be configured to supply at least one pilot combustion reagent stream to a downstream abatement chamber of the abatement apparatus. The inlet head assembly may comprise a plurality of inlet nozzles. Each inlet nozzle may extend within or through the inlet head. Each inlet nozzle may be configured to supply an associated effluent stream to be abated within the abatement chamber. The inlet nozzles may be positioned around the pilot nozzle. The inlet nozzles may be angled at an angle between 5° and 60°, preferably between 5° and 45°, and more preferably 5° and 20°, with respect to the axial orientation of said pilot nozzle. In this way, the effluent streams are clustered and packed closer together around and directed towards the pilot nozzle which improves the heating of the effluent stream, improving the DRE and reducing heat loss, which enables a reduction in the combustion reagents needing to be supplied.

The plurality of inlet nozzles may be each configured to supply a different associated effluent stream for abatement within the abatement chamber. Hence, inlet nozzles may supply different, potentially chemically-incompatible, effluent streams to the abatement chamber. This helps to ensure that those incompatible effluent streams remain separated outside of the abatement chamber, minimizing any undesirable and potentially hazardous chemical reactions upstream of the abatement chamber.

The plurality of inlet nozzles may each be configured to supply the effluent stream together with at least an inner combustion reagent stream to provide an inner oxidising flame and comprise an outer annular nozzle configured to supply an outer combustion reagent stream to provide a coaxial flame to stabilise the inner oxidising flame. Hence, the inlet nozzles may produce an inner oxidising flame which is stabilized with a coaxial diffusion flame. Typically, these diffusion flames are colder, with a core of fuel gas diffusing into an oxidant rich surrounding environment, these flames have the benefit of easily anchoring onto a surface. Packing each of those inlet nozzles around the pilot helps to share heat between the effluent streams and reduces heat loss which enables the outer combustion reagent to be supplied in smaller amounts to provide the coaxial flame whilst still retaining the required DRE.

The plurality of inlet nozzles may be positioned to at least partially surround the pilot nozzle.

The plurality of inlet nozzles may be positioned circumferentially around the pilot nozzle.

The plurality of inlet nozzles may be equally spaced circumferentially around the pilot nozzle.

The plurality of inlet nozzles may be positioned on a pitch circle around the pilot nozzle.

The plurality of inlet nozzles and the pilot nozzle may be positioned to abut each other, spaced apart by at least one of a flow stability and a combustion reagent supply distance. Hence, the nozzles may be positioned adjacent or proximate each other with a slight gap or spacing therebetween.

The pilot nozzle may be configured to initiate combustion of the at least one pilot combustion reagent stream, the plurality of inlet nozzles are configured to supply at least one combustion reagent stream with the effluent stream and are positioned to propagate combustion of the combustion reagent stream supplied by each inlet nozzle from the at least one pilot combustion reagent stream. In other words, the effluent streams supplied by each of the inlet nozzles may each be directly ignited from the ignited stream being provided by the pilot nozzle.

The pilot nozzle may comprise an inner nozzle configured to supply a first combustion reagent stream and an outer nozzle configured to supply a second combustion reagent stream as an annular curtain at least partially surrounding the first combustion reagent stream. Hence, the pilot nozzle may have an inner flow and a coaxial, annular outer flow.

The inlet head assembly may comprise a further combustion reagent nozzle extending within the inlet head and configured to supply at least one further combustion reagent stream to a downstream abatement chamber of the abatement apparatus. Hence, at least one further or additional combustion reagent nozzle which supplies a further combustion reagent may be provided.

According to a second aspect there is provided an inlet head assembly for an abatement apparatus for abating an effluent stream from a semiconductor processing tool, said inlet head assembly comprising an inlet head; a pilot nozzle extending within said inlet head and configured to supply at least one pilot combustion reagent stream to a downstream abatement chamber of said abatement apparatus; and a plurality inlet nozzles, each extending within said inlet head and configured to supply an associated effluent stream for abatement within said abatement chamber, said plurality of inlet nozzles being positioned around said pilot nozzle; comprising a further combustion reagent nozzle extending within said inlet head and configured to supply at least one further combustion reagent stream to a downstream abatement chamber of said abatement apparatus, wherein at least one of said plurality of inlet nozzles and said further combustion reagent nozzle is orientated to be angled with respect to said pilot nozzle and preferably wherein at least one of said plurality of inlet nozzles and said further combustion reagent nozzle is orientated supply at least one of said effluent stream and said further combustion reagent stream angled with respect to said pilot combustion reagent stream.

Unless otherwise stated, references to combustion reagent nozzle described below refer to both the first and second aspects of the invention.

The combustion reagent nozzle may be configured to supply the at least one further combustion reagent stream to at least partially surround those plurality of effluent streams supplied to the abatement chamber by the plurality of inlet nozzles. Hence, the further combustion reagent may be provided around the plurality of effluent streams. This helps to maintain the temperature of the effluent stream within the abatement chamber to improve DRE whilst reducing heat loss and reducing combustion reagent usage.

The further combustion reagent nozzle may be configured to supply the at least one further combustion reagent stream as an annular curtain at least partially surrounding those plurality of effluent streams supplied to the abatement chamber by the plurality of inlet nozzles.

The further combustion reagent nozzle may be positioned to propagate combustion of the at least one further combustion reagent stream from the combustion reagent stream supplied by each inlet nozzle. In other words, the further combustion reagent may be ignited directly by the effluent streams provided by the inlet nozzle which may, in turn, be directly ignited from the combustion reagent stream being provided by the pilot nozzle.

The further combustion reagent nozzle may comprise a first combustion reagent nozzle configured to supply a first combustion reagent stream and a second combustion reagent nozzle configured to supply a second combustion reagent stream.

The first combustion reagent nozzle may comprise a first annular nozzle configured to supply the first combustion reagent stream as a first annular curtain at least partially surrounding those plurality of effluent streams supplied to the abatement chamber by the plurality of inlet nozzles and the second combustion reagent nozzle comprises a second annular nozzle at least partially surrounding the first annular nozzle and is configured to supply the second combustion reagent stream as a second annular curtain at least partially surrounding the first annular curtain.

The further combustion reagent nozzle may at least partially surround the plurality of inlet nozzles. Hence, the effluent streams provided by the inlet nozzles may be collectively surrounded by both the combustion reagent stream provided by the further combustion reagent nozzle and the combustion reagent stream provided by the pilot nozzle. This helps to maintain the temperature of the effluent stream within the abatement chamber to improve DRE whilst reducing heat loss and reducing combustion reagent usage.

The further combustion reagent nozzle may be positioned concentrically with the pilot nozzle.

The first combustion reagent stream may comprise a fuel and the second combustion reagent stream may comprise an oxidant.

At least one of the plurality of inlet nozzles and the further combustion reagent nozzle according to the second aspect may be orientated to be parallel with the pilot nozzle.

At least one of the plurality of inlet nozzles and the further combustion reagent nozzle may be orientated to supply at least one of the effluent stream and the further combustion reagent stream parallel with the pilot combustion reagent stream.

The further combustion reagent nozzle according to the first aspect may be orientated to be angled with respect to the pilot nozzle.

At least one of the plurality of inlet nozzles and the further combustion reagent nozzle may be orientated supply at least one of the effluent stream and the further combustion reagent stream may be angled with respect to the pilot combustion reagent stream.

At least one of the plurality of inlet nozzles and the further combustion reagent nozzle may be orientated towards the pilot nozzle.

At least one of the plurality of inlet nozzles and the further combustion reagent nozzle may be orientated to supply at least one of the effluent stream and the further combustion reagent stream to converge with the pilot combustion reagent stream.

At least one of the plurality of inlet nozzles and the further combustion reagent nozzle may be orientated away from the pilot nozzle.

At least one of the plurality of inlet nozzles and the further combustion reagent nozzle may be orientated to supply at least one of the effluent stream and the further combustion reagent stream to diverge from the pilot combustion reagent stream.

At least one of the plurality of inlet nozzles and the further combustion reagent nozzle may orientated with an angle of up to 60°, preferably up to 45°, preferably up to 20°, preferably up to 15°, preferably up to 12.5°, and preferably up to 10°.

According to a third aspect, there is provided a method comprising providing an inlet head assembly for an abatement apparatus for abating an effluent stream from a semiconductor processing tool, said inlet head assembly comprising: an inlet head; a pilot nozzle extending within said inlet head and configured to supply at least one pilot combustion reagent stream to a downstream abatement chamber of said abatement apparatus; and a plurality inlet nozzles, each extending within said inlet head and configured to supply an associated effluent stream for abatement within said abatement chamber, said plurality of inlet nozzles being positioned around said pilot nozzle.

The method may comprise features corresponding to the features of the inlet head assembies set out above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 is a side cross-sectional view of a portion of an inlet head assembly and a view from within the abatement chamber towards the inlet head assembly according to one embodiment;

FIG. 2 is a side cross-sectional view of a portion of an inlet head assembly according to one embodiment;

FIG. 3 is a side cross-sectional view of a portion of an inlet head assembly and a view from within the abatement chamber towards the inlet head assembly according to one embodiment; and

FIG. 4 illustrates the relative performance between the inlet assembly of FIG. 4 and a conventional inlet assembly where the inlet nozzles are spaced further apart and do not surround the pilot nozzle.

### DETAILED DESCRIPTION

Before discussing the embodiments in any more detail, first an overview will be provided. Embodiments provide an arrangement for an abatement apparatus where inlet nozzles which supply one or more effluent streams to the abatement apparatus for abatement therein are positioned or located proximate to a pilot nozzle which supplies combustion reagents to assist in the abatement of the effluent stream in the abatement chamber. The positioning of the inlet nozzles in relation to the pilot nozzle helps to reduce heat loss and increase the temperature of the effluent stream within the abatement chamber, which improves the destruction rate efficiency of compounds within the effluent stream. In some embodiments, the inlet nozzles are positioned around the pilot nozzle to ensure close proximity of each effluent stream to the combustion reagents supplied by the pilot nozzle. In some embodiments, a further nozzle is provided which surrounds the inlet nozzles to provide combustion reagents around the effluent streams provided by those inlet nozzles. This again helps to increase the DRE by reducing heat loss experienced by the effluent streams and increasing the temperature of the effluent stream within the abatement chamber. The pilot nozzle, inlet nozzles and the further nozzle may be positioned and/or configured to deliver the combustion reagent streams and the effluent streams to be parallel or at an angle with respect to each other. This helps to vary the temperature and/or the interaction between the effluent stream and the combustion reagents in order to vary the DRE of compounds within the effluent streams.

### Inlet Head Assembly—Converging Flows

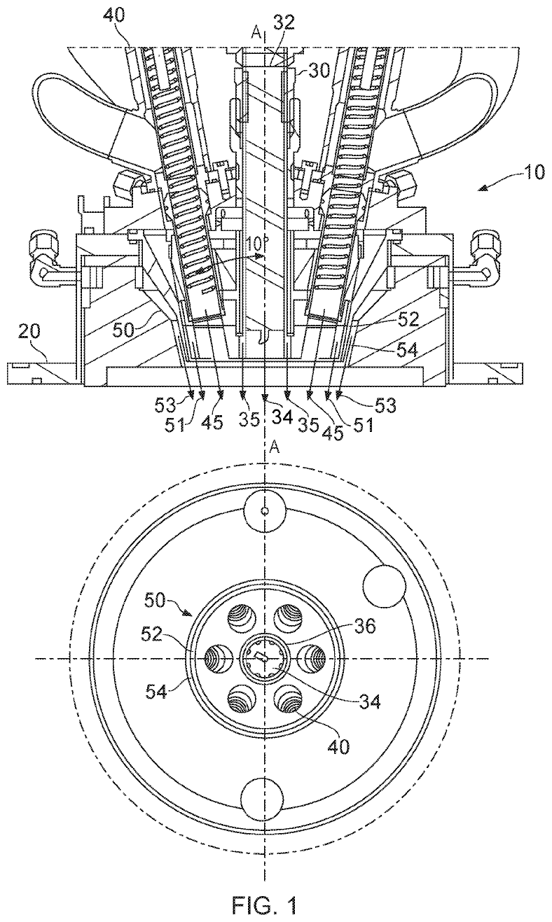

FIG. 1 is a cross-sectional view of an inlet head assembly 10, according to one embodiment. The inlet head assembly comprises an inlet head 20 which attaches to a downstream abatement chamber (not shown). The inlet head 20 has a pilot nozzle 30 positioned at the centre of the inlet head 20. The pilot nozzle 30 extends within the inlet head 20. The pilot nozzle 30 has an inner nozzle 32 configured to deliver fuel 34 to the abatement chamber in an (vertically) axial direction A-A. The pilot nozzle has an outer nozzle 36 configured to deliver compressed dried air (CDA) 38 (or another oxidant) in the axial direction A-A as an annular curtain surrounding the fuel 34.

A plurality of inlet nozzles 40 (in this example there are six inlet nozzles 40), are equally spaced with a pitched circle diameter surrounding the pilot nozzle 32. However, it will be appreciated that other configurations are possible. The inlet nozzles 40 extend within the inlet head 20. The inlet nozzles 40 are each angled at an angle with respect to the orientational axis of the pilot nozzle 30. In this example, the pilot nozzle 30 is orientated in the axial direction A-A and each of the inlet nozzles 40 are angled at an angle of 10° with respect to the pilot nozzle (axial direction A-A). The nozzles can be angled at between 5° and 60° with respect to axial direction A-A. Each of the inlet nozzles 40 delivers an associated effluent stream 45 (in this example, up to six different effluent streams, although different inlet nozzles 40 may be also configured to deliver the same effluent stream), optionally pre-mixed with fuel and/or an oxidant, as required to the downstream abatement chamber. Hence, each of the inlet nozzles 40 delivers an associated effluent stream 45 at an angle to the fuel 34 and the CDA 38 provided to the abatement chamber by the pilot nozzle 30.

A further combustion reagent nozzle 50 is provided which surrounds both the pilot nozzle 30 and the plurality of inlet nozzles 40. In this example, the further reagent nozzle comprises an inner combustion reagent nozzle 52 which provides an annular opening and delivers an annular curtain of fuel 51 surrounding the effluent streams provided by the inlet nozzles 40. The further reagent nozzle 50 also comprises an outer combustion reagent nozzle 54 which surrounds and is concentrically located with the inner combustion reagent nozzle 52 and which also provides an annular outlet which provides an annular curtain of CDA 53 surrounding the annular curtain of fuel 51 provided by the inner combustion reagent nozzle 52. The inner combustion reagent nozzle 52 and the outer combustion reagent nozzle 54 are positioned and configured to provide the fuel 51 and CDA 53 also at an angle to the fuel 34 and the CDA 38 provided to the abatement chamber by the pilot nozzle 30.

Although in this example both the inlet nozzles 40 and the further combustion reagent nozzle 50 (and their component nozzles) are angled with the same angle with respect to the pilot nozzle 30, it will be appreciated that need not be the case and that individual nozzles (and their component nozzles) can be angled separately depending on the abatement requirements.

In operation, the pilot nozzle 30 delivers fuel 34 and CDA 38 to the abatement chamber which is ignited. The inlet nozzles 40 deliver the effluent stream 45 optionally mixed with fuel and oxidant at an angle with respect to the pilot nozzle 30 which causes the effluent streams 45 to converge on the flame boundary extending from the pilot 30, which causes the effluent streams 45 to ignite. The further combustion reagent nozzle 50 delivers an annular curtain of fuel 51 and CDA 53 which surrounds the effluent streams 45 and which ignites from the effluent streams 45. This provides a further flame boundary around the effluent streams 45 exiting from the inlet nozzles 40 which also converges towards the flame extending from the pilot nozzle 30. This arrangement helps to reduce heat loss and improve the heating in the vicinity of the effluent streams 45 within the abatement chamber, which helps to improve the destruction rate efficiency of compounds within the effluent streams 45.

### Inlet Head Assembly—Parallel and Converging Flows

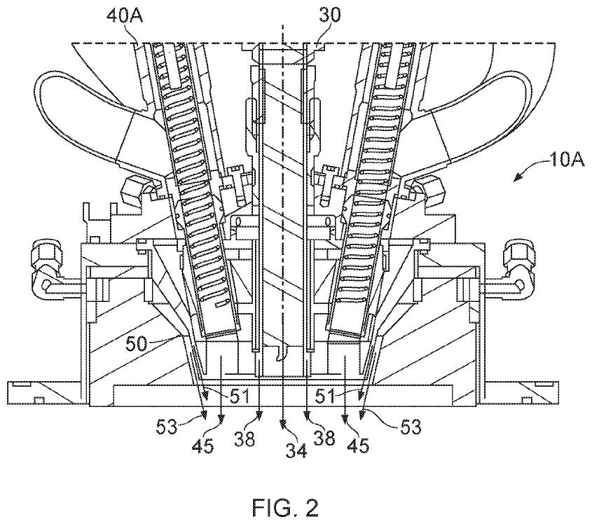

FIG. 2 illustrates an inlet head assembly 10A according to one embodiment. This embodiment is similar to that described in FIG. 1 above, with the exception that the inlet nozzles 40A are configured at the entry to the abatement chamber to deliver the effluent stream 45 parallel with the fuel 34 and CDA 38 being provided by the pilot nozzle 30 while the fuel 51 and the CDA 53 being delivered by the further combustion reagent nozzle 50 remains angled with respect to the axial direction A-A.

### Inlet Head Assembly—Divergent Flows

In a further embodiment (not shown), the inlet nozzles and/or the further reagent nozzle are configured to be angled away from the pilot nozzle 30 so that the effluent streams 45 and/or the fuel 51 and CDA 54 are delivered at an angle away from and divergent from the fuel 34 and CDA 38 delivered by the pilot nozzle 30.

### Inlet Head Assembly—Omitted Further Combustion Reagent Nozzle

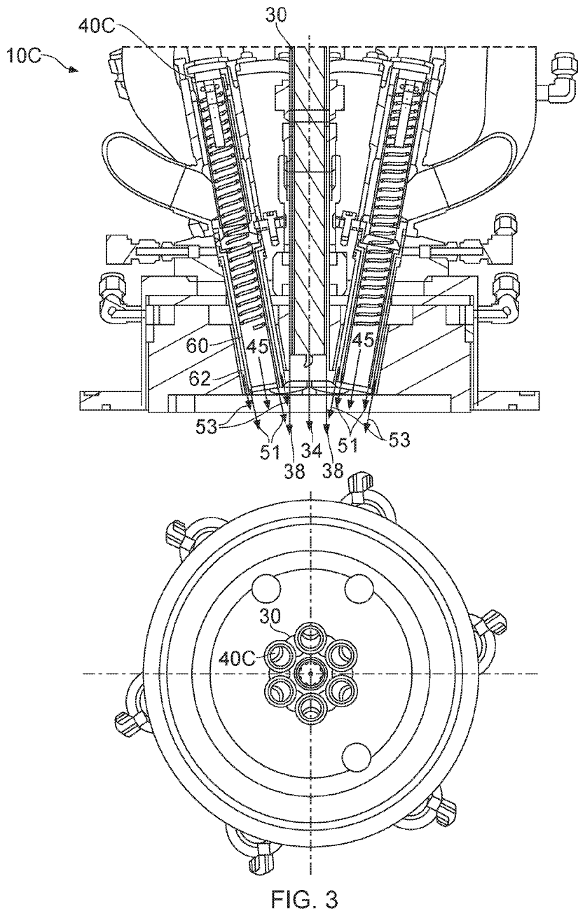

FIG. 3 illustrates an inlet head assembly 10C according to one embodiment. This embodiment is similar to that described in FIG. 1 above, the further combustion reagent nozzle 50 is omitted. Instead, each inlet nozzle 40C is provided with a first outer nozzle 60 configured to deliver fuel 51 as an annular curtain surrounding the effluent stream 45 and a second outer nozzle 62 around the first outer nozzle 60 and configured to deliver CDA as an annular curtain surrounding the fuel 51.

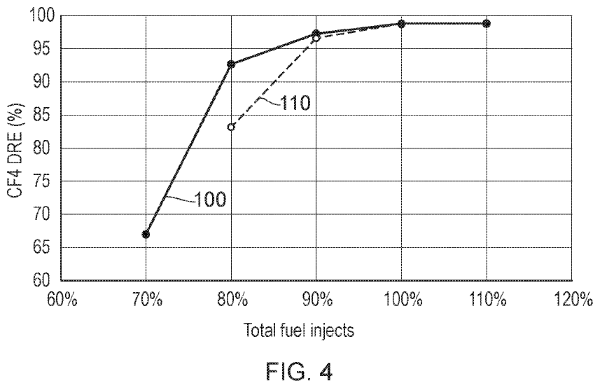

FIG. 4 illustrates the relative performance between the inlet assembly 10C (line 100) and a conventional inlet assembly (line 110) where the inlet nozzles are spaced further apart and do not surround the pilot nozzle. As can be see, with the same total amount of fuel set at 80%, the DRE of the inlet assembly 10C around 93% whereas the DRE of the conventional inlet assembly is around 85%. As can also be seen, the inlet assembly 10C can achieve the same DRE as the conventional inlet assembly with less fuel.

In some embodiments, due to the proximity of the nozzles within the head and burner, the high energy reducing flames created to destroy Perfluorinated compounds (PFCs-mainly CF₄) can share heat and reactants. This cluster arrangement locates the nozzles closer together in order to maximise the transfer of heat and reactants in order to reduce fuel and oxygen used in PFC combustion. Hence, this arrangement improves CF₄ DRE whilst reducing fuel and oxygen during CF4 combustion.

Some embodiments use a swept inlet nozzle design. The inlet nozzle removes the effluent stream or process flow gas bias, aids better mixing of the lance fuel and incoming process gas and allows a longer residence time of the resulting mixture before entering the coaxial flame.

In some embodiments, the primary function of this arrangement is to reduce the space between inlet nozzles so that during CF₄ combustion the inlet flame loses less heat and utilises and spare reactants from neighbouring inlets nozzles resulting in higher efficiency and thus allowing a reduction of fuel and oxygen. Angling the nozzles to reduce space between inlet flames allows flames to share heat/reactants during abatement. A lower fuel and oxygen usage across 6 inlet nozzles lowers the cost of ownership while maintaining DRE performance.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. An inlet head assembly for an abatement apparatus for abating an effluent stream from a semiconductor processing tool, said inlet head assembly comprising:
an inlet head;
a pilot nozzle, extending within said inlet head and configured to supply at least one pilot combustion reagent stream to a downstream abatement chamber of said abatement apparatus; and
a plurality inlet nozzles, each extending within said inlet head, at an angle between 5° and 60°, preferably between 5° and 45° and more preferably between 5° and 20°, with respect to the axial orientation of said pilot nozzle and configured to supply an associated effluent stream for abatement within said abatement chamber, said plurality of inlet nozzles being positioned around said pilot nozzle.

2. The inlet head assembly of claim 1, wherein said plurality of inlet nozzles are at least one of:
positioned to at least partially surround said pilot nozzle;
positioned circumferentially around said pilot nozzle;
equally spaced circumferentially around said pilot nozzle; and
positioned on a pitch circle around said pilot nozzle.

3. The inlet head assembly of claim 1, wherein said plurality of inlet nozzles and said pilot nozzle are positioned to abut each other, spaced apart by at least one of a flow stability and a combustion reagent supply distance.

4. The inlet head assembly of claim 1, wherein said pilot nozzle is configured to initiate combustion of said at least one pilot combustion reagent stream and said plurality of inlet nozzles are configured to supply at least one combustion reagent stream with said effluent stream and are positioned to propagate combustion of said combustion reagent stream supplied by each inlet nozzle from said at least one pilot combustion reagent stream.

5. The inlet head assembly of claim 1, wherein said pilot nozzle comprises an inner nozzle configured to supply a first combustion reagent stream and an outer nozzle configured to supply a second combustion reagent stream as an annular curtain at least partially surrounding said first combustion reagent stream.

6. The inlet head assembly of claim 1, comprising a further combustion reagent nozzle extending within said inlet head and configured to supply at least one further combustion reagent stream to a downstream abatement chamber of said abatement apparatus.

7. An inlet head assembly for an abatement apparatus for abating an effluent stream from a semiconductor processing tool, said inlet head assembly comprising:
an inlet head;
a pilot nozzle extending within said inlet head and configured to supply at least one pilot combustion reagent stream to a downstream abatement chamber of said abatement apparatus; and
a plurality inlet nozzles, each extending within said inlet head and configured to supply an associated effluent stream for abatement within said abatement chamber, said plurality of inlet nozzles being positioned around said pilot nozzle;
comprising a further combustion reagent nozzle extending within said inlet head and configured to supply at least one further combustion reagent stream to a downstream abatement chamber of said abatement apparatus,
wherein at least one of said plurality of inlet nozzles and said further combustion reagent nozzle is orientated to be angled with respect to said pilot nozzle and preferably wherein at least one of said plurality of inlet nozzles and said further combustion reagent nozzle is orientated supply at least one of said effluent stream and said further combustion reagent stream angled with respect to said pilot combustion reagent stream.

8. The inlet head assembly of claim 6, wherein said further combustion reagent nozzle is at least one of:
configured to supply said at least one further combustion reagent stream to at least partially surround those plurality of effluent streams supplied to the abatement chamber by said plurality of inlet nozzles; and
configured to supply said at least one further combustion reagent stream as an annular curtain at least partially surrounding those plurality of effluent streams supplied to the abatement chamber by said plurality of inlet nozzles.

9. The inlet head assembly of claim 6, wherein said further combustion reagent nozzle is positioned to propagate combustion of said at least one further combustion reagent stream from said combustion reagent stream supplied by each inlet nozzle.

10. The inlet head assembly of claim 6, wherein
said further combustion reagent nozzle comprises at least one of:
a first combustion reagent nozzle configured to supply a first combustion reagent stream and a second combustion reagent nozzle configured to supply a second combustion reagent stream; and
a first annular nozzle configured to supply said first combustion reagent stream as a first annular curtain at least partially surrounding those plurality of effluent streams supplied to the abatement chamber by said plurality of inlet nozzles and said second combustion reagent nozzle comprises a second annular nozzle at least partially surrounding said first annular nozzle and is configured to supply said second combustion reagent stream as a second annular curtain at least partially surrounding said first annular curtain.

11. The inlet head assembly of claim 6, wherein said further combustion reagent nozzle at least partially surrounds said plurality of inlet nozzles, and/or wherein said further combustion reagent nozzle is positioned concentrically with said pilot nozzle; and/or wherein said first combustion reagent stream comprises a fuel and said second combustion reagent stream comprises an oxidant.

12. The inlet head assembly of claim 6, wherein at least one of said plurality of inlet nozzles and said further combustion reagent nozzle is orientated to be parallel with said pilot nozzle and preferably wherein at least one of said plurality of inlet nozzles and said further combustion reagent nozzle is orientated to supply at least one of said effluent stream and said further combustion reagent stream parallel with said pilot combustion reagent stream.

13. The inlet head assembly of claim 6, wherein at least one of said plurality of inlet nozzles and said further combustion reagent nozzle is orientated to be angled with respect to said pilot nozzle orientated in the axial direction and preferably wherein at least one of said plurality of inlet nozzles and said further combustion reagent nozzle is orientated supply at least one of said effluent stream and said further combustion reagent stream angled with respect to the axial direction of said pilot combustion reagent stream.

14. The inlet head assembly of claim 6, wherein at least one of said plurality of inlet nozzles and said further combustion reagent nozzle is orientated towards said pilot nozzle and preferably wherein at least one of said plurality of inlet nozzles and said further combustion reagent nozzle is orientated to supply at least one of said effluent stream and said further combustion reagent stream to converge with said pilot combustion reagent stream.

15. The inlet head assembly of claim 6, wherein at least one of said plurality of inlet nozzles and said further combustion reagent nozzle is orientated away from said pilot nozzle and preferably wherein at least one of said plurality of inlet nozzles and said further combustion reagent nozzle is orientated to supply at least one of said effluent stream and said further combustion reagent stream to diverge from said pilot combustion reagent stream.

16. The inlet head assembly of claim 6, wherein at least one of said plurality of inlet nozzles and said further combustion reagent nozzle is orientated with an angle of up to 60°, preferably up to 45°, preferably up to 20°, preferably up to 15°, preferably up to 12.5°, and preferably up to 10°.
